(19) United States
(12) Patent Application Publication
(10) Pub. No.: US 2020/0128333 A1
(43) Pub. Date: Apr. 23, 2020

(54) DIAGONAL RESONANCE SOUND AND ULTRASONIC TRANSDUCER

(71) Applicant: MICROFINE MATERIALS TECHNOLOGIES PTE LTD, Singapore (SG)

(72) Inventors: Shuangjie ZHANG, Singapore (SG); Leong Chew LIM, Singapore (SG); Dianhua LIN, Singapore (SG)

(21) Appl. No.: 16/624,445

(22) PCT Filed: Jun. 19, 2017
(86) PCT No.: PCT/SG2017/050309

§ 371 Date: Dec. 19, 2019

(51) Int. Cl. H04R 17/10; H04R 1/44; H04R 17/00

(52) U.S. Cl. CPC H04R 17/10; H04R 2400/01; H04R 17/005; H04R 1/44

(57) ABSTRACT

The invention provides a Diagonal Resonance (DR) mode for sound and ultrasound generation and reception. This new driving mode is made possible due to the anisotropic sound velocity in piezoelectric single crystals. This gives rise to a crossed slab active material, which contains the crossed-diagonals of the substantially rectangular shaped active material, exhibiting comparable resonance frequency. Due to reasonably large Piosson's ratios of lead-based relaxor single crystal, the resonance vibration of the active material in crossed face or body diagonal directions induces sufficiently large vibration amplitudes for sound and ultrasound generation via any free surface which could be normal or at an angle to the resonating diagonal directions. Said DR mode typically has lower resonance frequency than conventional longitudinal and transverse width modes but high TVR and can be combined or coupled with said two driving modes to make broadband to extra-broadband sonic and ultrasonic transducers.

### TECHNICAL FIELD

The present invention relates to piezoelectric transducers, and more particularly, to arrays of piezoelectric transducers for sound and ultrasound generation, transmission and reception.

### BACKGROUND OF THE INVENTION

Underwater communication can be complex due to factors such as multi-path propagation, time variations of the channel, small available bandwidth and strong signal attenuation, especially over long ranges. Further, compared to terrestrial communication, underwater communication has low data rates because it uses acoustic waves instead of electromagnetic waves. Underwater Acoustic Transducers are often used for ship and submarine sonar, oceanographic surveying, seismic exploration, marine life research, medical devices and industrial proximity sensing.

Modern underwater acoustic transducers are typically electromechanical transducers driven by piezoelectric materials such as lead zirconate titanate (PbZr_{0.52}Ti_{0.48}O₃ or PZT) polycrystalline ceramics, relaxor based single crystals, and piezoceramic-polymer composites of rectangular, disk, rod, tube or spherical shape. A number of driving modes of the active element can be employed depending on the purpose and material characteristics. The most commonly used driving modes include longitudinal (33 or LG) mode and conventional transverse width (31 or CTW) mode.

In longitudinal (33 or LG) mode operation, the active element is activated along the poling (3-) direction and the acoustic beam is generated in the same direction. In the conventional transverse width (31, or CTW) mode operation, the active element of a transducer is activated in resonance along one of the two lateral or transverse directions, which is also the acoustic beam direction. Accordingly, in these operating modes, the resonating and the acoustic beam are in the same direction.

FIG. 1a shows an example of a transmitting element 100 operating in the longitudinal (LG) mode. In this figure, an active element 102 is bonded onto a backing material 104. The backing material 104 is a soft and high-damping backing material, which has the effect of decreasing ringing of the active element 102 for improved axial resolution when short pulse length signal is used. The shaded top and bottom surfaces 106 and 108 indicate electrodes on the active element. In response to an input alternating voltage applied in the poling (3-) direction, the active element 102 vibrates and radiates acoustic energy to the surrounding medium in said direction.

An example of a conventional transverse width mode transducer element 200 is provided in FIG. 2a. In this example, the active element 202 is poled along the 3-direction across its electrode surface 204 and the face opposite (not shown in figure). A heavy tail mass 206 is used to help project the acoustic energy towards the top direction. The active element 202 vibrates and radiates acoustic energy to the surrounding medium along the same lateral transverse direction.

FIG. 2b depicts a new transverse width driving mode as described by Zhang and Lin (WO 2015/126321 A1). In this mode, the active element 202 is activated in resonance in a transverse direction orthogonal to its poling (3-) direction and acoustic wave is generated in another transverse direction or the longitudinal direction, both of which are orthogonal to the resonating direction. This mode is referred to hereinafter as the Transverse Resonance Orthogonal Beam (TROB) mode.

FIG. 1b depicts an LG type transducer 100 under the TROB mode of operation. In this figure, the active element 102 is activated in one or both of its lateral direction(s) orthogonal to its poling (3-) direction. The acoustic beam is generated along the poling (3- or LG) direction, which is orthogonal to the resonating direction(s).

The TROB driving mode is possible due to the extremely high piezoelectric strain coefficients (dᵢⱼ), electromechanical coupling factors (kᵢⱼ), and Poisson's ratio effect in new generation lead-based relaxor solid solution single crystals, such as Pb[Zn_{1/3}Nb_{2/3}]O₃—PbTiO₃ (PZN-PT), Pb[Mg_{1/3}Nb_{2/3}]O₃—PbTiO₃ (PMN-PT), Pb[Mg_{1/3}Nb_{2/3}]O₃—PbZrO₃—PbTiO₃ (PMN-PZT) and Pb[In_{1/2}Nb_{1/2}]O₃—Pb[Mg_{1/3}Nb_{2/3}]O₃—PbTiO₃, (PIN-PMN-PT) solid solution crystals.

For example, [001]-poled PZN-6% PT single crystals have superior longitudinal (d₃₃≈2700 pC/N, k₃₃≈0.93) and good transverse piezoelectric properties (d₃₁≈−1560 pC/N, k₃₁≈0.85). And for [011]-poled PZN-5.5% PT single crystal, d₃₃≈1900 pC/N, d₃₂≈2600 pC/N, k₃₃≈0.92, k₃₂≈0.90. The latter crystal cut also has high Poisson's ratios. For instance, v₁₂^{E}≈−0.89. (see for example, A. A. Heitmann, J. A. Stace, L. C. Lim and A. H. Amin, “Influence of compressive stress and electric field on the stability of [011] poled and [0-11] oriented 31-mode PZN-0.055PT single crystals”, Journal of Applied Physics, vol. 119, 224101, 2016).

### OBJECTS OF THE INVENTION

It is an object of the present invention to extend the TROB mode of the prior art to transverse directions other than the two lateral width directions. More specifically, for a longitudinal-mode rectangular active element, the present invention provides that a TROB mode can also be activated in the crossed-face-diagonal transverse directions, or over a crossed-angular sector covering both face diagonal directions. The driving mode of the invention may thus be hereafter referred to as the diagonal-transverse-resonance-orthogonal beam (D-TROB) mode.

It is also an object of the present invention to extend the diagonal resonance mode to a transverse-mode active element. In this case, the resonating diagonal directions are at acute angles to the transverse mode acoustic beam direction. This mode, as well as the D-TROB mode described herein, are collectively referred to as the Diagonal Resonance (DR) driving mode, for simplicity.

It is also an object of the present invention to provide a sound or ultrasound transmitting element and its array which operates a DR mode described herein.

It is also an object of the present invention to provide a transducer designed to operate in either multiple resonance frequency modes of which at least one of the resonant modes is a DR mode, or a broadband coupled mode of which at least one of the fundamental modes is a DR mode, or in other derivative forms such as with a suitable head mass and/or an intermediate mass, matching and/or lens layer, with or without a tail mass.

It is further an object of the present invention to utilize the DR mode in sound and ultrasound generation and reception in the underwater, medical and industrial fields.

### SUMMARY OF THE INVENTION

The invention includes a transducer that is comprised of an active element of rectangular shape or substantially rectangular shape, electroded on two opposite faces and poled across the electrode faces. The active element can be set either in half-wavelength or quarter-wavelength resonance mode such that the resonating directions are along crossed face-diagonal directions or substantially crossed face-diagonal directions of an external face of the active element. An acoustic beam is generated in a direction which is orthogonal or at an acute angle to the resonating diagonal directions.

The invention also includes a transducer comprised of a longitudinal-mode active element of rectangular shape or substantially rectangular shape, electroded on two opposite faces and poled across the electrode faces. The active element can be set in half-wavelength resonance mode in along crossed face-diagonal directions or substantially along crossed face-diagonal directions of the electrode face of the active element. An acoustic beam is generated along a longitudinal poling direction which is orthogonal to the resonating diagonal directions.

Further, the invention includes a transducer comprised of an active element of rectangular shape or substantially rectangular shape, electrode on two opposite faces and poled across the electrode faces, that can be set either in half-wavelength or quarter-wavelength resonance mode such that the resonating directions are along crossed body-diagonal directions or substantially crossed body-diagonal directions of the active element. An acoustic beam is generated in a direction that is at an orthogonal or acute angle to the resonating direction.

The active element can be comprised of a plurality of active materials connected in one of a parallel, series, part-parallel or part-series electrical configuration. The corners of the active element can be chamfered, filleted or shaped with curvature to promote the diagonal resonance (DR) mode.

Further, the active element can be comprised of compositions and cuts of piezoelectric single crystals which possess transverse piezoelectric properties of d₃₁ (or d₃₂)≥400 pC/N and k₃₁ (or k₃₂)≥0.60 in at least one of the transverse directions, wherein d₃₁ and d₃₂ refer to the associated transverse piezoelectric strain coefficients and k₃₁ and k₃₂ refer to the associated electromechanical coupling factors. The active element can be comprised of cuts of relaxor based ferroelectric or piezoelectric single crystals of binary, ternary, and higher-order solid solutions of one or more of Pb(Zn_{1/3}Nb_{2/3})O₃, Pb(Mg_{1/3}Nb_{2/3})O₃, Pb(In_{1/2}Nb_{1/2})O₃, Pb(Sc_{1/2}Nb_{1/2})O₃, Pb(Fe_{1/2}Nb_{1/2})O₃, Pb(Yb_{1/2}Nb_{1/2})O₃, Pb(Lu_{1/2}Nb_{1/2})O₃, Pb(Mn_{1/2}Nb_{1/2})O₃, PbZrO₃ and PbTiO₃, including their modified and/or doped derivatives.

Further, the active element can be comprised of a [001]₃-poled single crystal of [1-10]₁×[110]₂×[001]₃ cut, where [001]₃ is the longitudinal direction, and [1-10]₁ and [110]₂ are the two lateral or transverse directions. The active element can be comprised of compositions of textured polycrystalline ceramics which possess transverse piezoelectric properties of d₃₁ (or d₃₂)≥400 pC/N and k₃₁ (or k₃₂)≥0.60 in at least one of the transverse directions. In the alternative, the active element can be comprised of modified compositions of piezoelectric single crystal or textured polycrystalline piezoelectric ceramics which possess transverse piezoelectric properties of d₃₁ (or d₃₂)≥400 pC/N and k₃₁ (or k₃₂)≥0.60 in at least one of the transverse directions.

In another embodiment, the transducer includes an intermediate mass bonded in between the active materials. It can also include a tail mass bonded onto the face opposite to the acoustic wave emitting face of the active element. The transducer can be a direct-drive, piston-less design. Further, the transducer can comprise a head mass of either a rigid or flexural type.

The transducer can further comprise a matching layer attached to the acoustic wave emitting face of the active element. The transducer can also include a lens layer provided on top of the matching layer. The transducer can operate in a combined, multi-resonance mode or a coupled mode. The transducer can be used for sound/ultrasound generation, transmission and reception.

### INTRODUCTION

The objects of the invention are achieved by making use of distribution of sound velocity and hence frequency constant in an active element to excite a new operating mode, called the Diagonal Resonance (DR) mode, of piezoelectric transducers for sound and ultrasound generation and reception.

According to an embodiment of the invention, a longitudinal-mode transducer made of an active element of rectangular-shape, is activated in transverse resonance along both crossed-face-diagonal directions, or a crossed-angular sector including the crossed diagonal directions, of the electrode face of the active element, so that the acoustic beam direction is generated in the longitudinal direction which is orthogonal to the resonating crossed-face-diagonal directions.

According to another embodiment of the invention, a transverse-mode transducer made of an active element of rectangular-shape or substantially so, is activated in transverse resonance along both face-diagonal directions, or a crossed angular sector including both crossed-face-diagonal directions, on the electrode face of the active element, such that the acoustic beam direction is generated along one of the transverse width directions of the active material which is at an acute angle to the resonating diagonal directions.

According to another embodiment of the present invention, the active element includes either a single piece of active material or a plurality of active materials of identical or comparable dimensions and cut, of substantially rectangular shape with or without chamfers or fillets of various dimensions at the corners, which are electrically connected in one of a parallel, series, part-parallel or part-series configuration.

According to another embodiment of the invention, the transducer includes a tail mass bonded onto the face opposite to the acoustic wave emitting face of the active element. The tail mass can be one of a heavy tail mass or a soft and high-damping backing material to suit a desired application.

According to another embodiment of the invention, the transducer includes one or more intermediate masses bonded in between the active materials to suit a desired application.

According to another embodiment of the invention, the transducer includes a direct-drive, piston-less design or with a head mass of either a rigid or flexural type to suit a desired application.

According to another embodiment of the invention, the transducer includes one or more matching layers attached to the acoustic wave emitting face of the active element.

According to another embodiment of the invention, the transducer includes one or more lens layers provided on top of the head mass or matching layer.

### BRIEF DESCRIPTIONS OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the disclosure is not limited to specific methods and instrumentalities disclosed herein. Moreover, those in the art will understand that the drawings are not to scale.

FIG. 1a is a schematic depicting the operating principle of a rectangular Longitudinal (LG)-mode transducer that includes an active element with a soft and high-damping backing layer resonating in half-wavelength LG mode in the poling direction according to prior art.

FIG. 1b depicts the transducer of FIG. 1a operating in half-wavelength transverse resonance orthogonal beam (TROB) mode described in WO 2015/126321 A1.

FIG. 2a is a schematic depicting the operating principle of a rectangular Conventional Transverse Width (CTW)-mode transducer that includes an active element with a stiff and heavy backing layer resonating in quarter-wavelength CTW mode in the acoustic beam direction according to prior art.

FIG. 2b depicts the transducer of FIG. 2a operating in half-wavelength Transverse Resonance Orthogonal Beam (TROB) mode described in WO 2015/126321 A1.

FIG. 3 depicts the operating principle of LG-type active element resonating in Diagonal Resonance (or D-TROB) mode according to an embodiment of the invention.

FIG. 4 depicts the operating principle of CTW-type element resonating in Diagonal Resonance mode according to another embodiment of the invention.

FIG. 5 is a plot showing the distribution of sound velocities in [001]₃-poled PZN-6% PT crystals as a result of orientation dependence of elastic compliance constant sᵢᵢ^{E}.

FIG. 6a is an exemplary plot of the normalized half-wavelength mode resonance frequencies along various radial directions in the square (001) electrode face of a rectangular shape active element of [001]₃-poled PZN-6% PT crystal of [1-10]₁×[110]₂×[001]₃ cut, where [001]₃ is the poling LG direction, and [1-10]₁ and [110]₂ are the two lateral or transverse directions. The crossed face diagonal directions in this case are along the [100]_{c} and [010]_{c} crystal directions.

FIG. 6b depicts the block of material activated under said resonance in response to input alternating voltage of 52 kHz.

FIG. 6c depicts the block of material activated under said resonance in response to input alternating voltage of 56 kHz.

FIG. 7 depicts a multi-crystal transducer operating under the Diagonal Resonance (DR) mode of the invention.

FIG. 8 shows the measured transmit voltage response (TVR) plot of the DR mode over 48 kHz to 63 kHz of the transducer described in FIG. 7.

FIG. 9a depicts other possible transducers excited under the DR mode of the invention. Here, the diagonal resonance occurs on a non-electrode face.

FIG. 9b illustrates examples of other possible transducers excited under the DR mode of the invention. Here, the diagonal resonance occurs along the four body diagonal directions within the active material.

FIG. 10a depicts a transducer of approximately rectangular shape active materials with large chamfers at the corners which are intended design features to promote the DR mode in the transducer.

FIG. 10b depicts a transducer of approximately rectangular shape active materials with fillets at the corners. The fillets or deliberately shaped curved corners are intended design features to promote the DR mode in the transducer.

### DETAILED DESCRIPTION OF THE INVENTION

Reference in this specification to “one embodiment/aspect” or “an embodiment/aspect” means that a particular feature, structure, or characteristic described in connection with the embodiment/aspect is included in at least one embodiment/aspect of the disclosure. The use of the phrase “in one embodiment/aspect” or “in another embodiment/aspect” in various places in the specification are not necessarily all referring to the same embodiment/aspect, nor are separate or alternative embodiments/aspects mutually exclusive of other embodiments/aspects. Moreover, various features are described which may be exhibited by some embodiments/aspects and not by others. Similarly, various requirements are described which may be requirements for some embodiments/aspects but not other embodiments/aspects. Embodiment and aspect can be in certain instances be used interchangeably.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks. The use of highlighting has no influence on the scope and meaning of a term; the scope and meaning of a term is the same, in the same context, whether or not it is highlighted. It will be appreciated that the same thing can be said in more than one way.

Consequently, alternative language and synonyms may be used for any one or more of the terms discussed herein. Nor is any special significance to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

Without intent to further limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions, will control.

### DESCRIPTION OF PREFERRED EMBODIMENTS

The invention provides a new operating mode for sound and/or ultrasound generation, transmission and reception. A transducer employing the new operating mode includes a rectangular-shape active element activated in resonance along the crossed-face-diagonal directions, or a crossed-angular sector including both crossed-face-diagonal directions, on the electrode face of the active element, so that the acoustic beam direction is generated along either the longitudinal direction or one of the transverse width directions.

The driving mode described herein differs from the Transverse Resonance Orthogonal mode (TROB) described by Zhang and Lin (WO 2015/126321 A1), where the resonating direction of the active material is along one or both transverse width direction(s) of the active element rather than the face diagonal directions.

This resonance mode is herein referred to as the Diagonal Resonance (DR) mode, and a transducer operating in such a resonance mode is herein referred to as a Diagonal Resonance (DR) transducer.

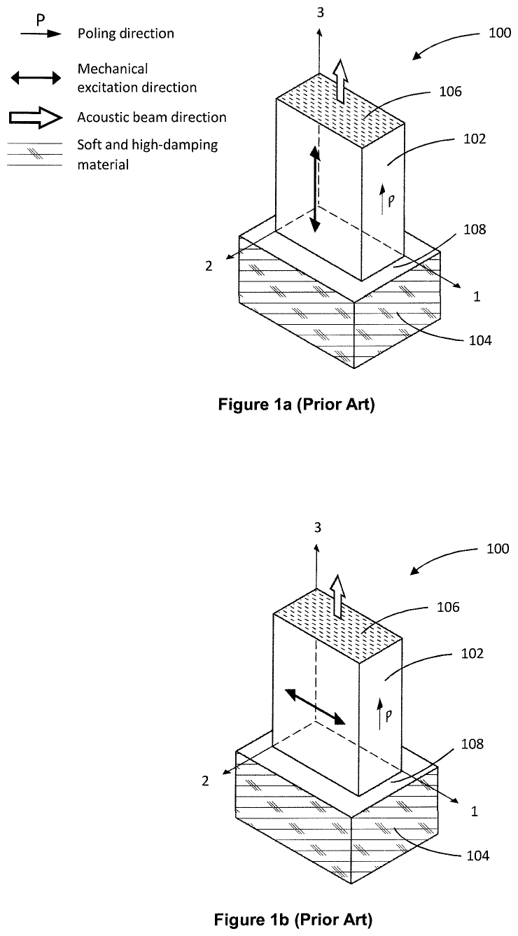

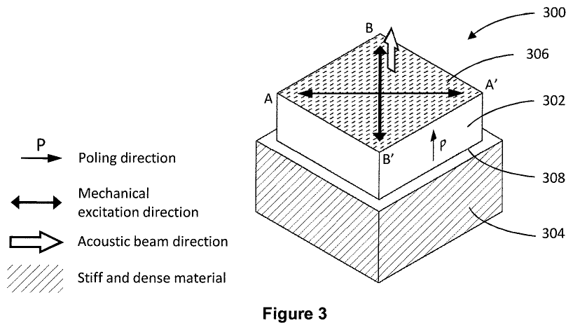

A transducer under the DR mode of operation includes a substantially rectangular active element with electrodes on two opposite faces and poled across the electrode faces. FIG. 3 shows an example of transducer 300 operating in the DR mode described herein. The active element 302 is bonded onto a heavy tail mass 304. The shaded top 306 and bottom surfaces 308 indicate the electrode faces. The active element 302 is activated in resonance along both transverse diagonal directions of the electrode face and the acoustic beam is generated in the orthogonal poling or LG direction. The excitation of the active element is depicted by mechanical excitation direction arrows (along AA′ and BB′ in the figure). In addition, the active material can also be activated in the conventional LG and TROB mode as described in FIGS. 1a and 1b. It should be noted that in this case, the resonating directions of both the TROB and DR modes are orthogonal to the acoustic beam direction.

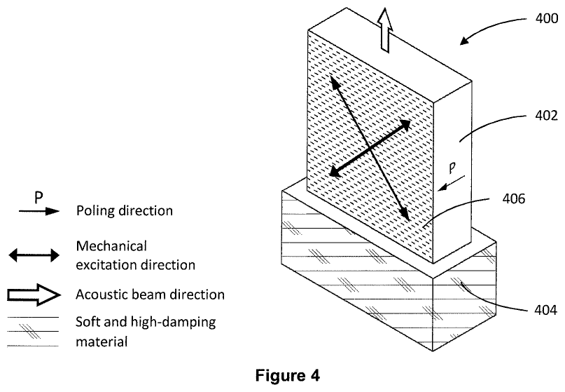

Alternatively, as shown in FIG. 4, the new DR mode can be activated in an active element having its acoustic beam direction along one of its two transverse width directions. The transducer 400 includes an active element 402, a backing element 404 made of a soft and high-damping material, two electrodes 406 and its opposite face. The resonating direction of the DR mode is in the face defined by the two transverse width directions of the active element. While the resonating direction of the TROB mode is at right angle to the acoustic beam direction, those of the DR mode are at acute angles to the acoustic beam direction in this case.

The DR driving mode disclosed herein is made possible by the distribution of sound velocity and hence resonance frequency in single crystal active elements due to the anisotropic sound velocity in relaxor based solid solution single crystals. Unlike PZT polycrystalline ceramics of which the properties are homogeneous in all transverse directions (of ∞m symmetry after poling), the properties of relaxor based multidomain single crystals are orientation dependent (See, for example, E. Sun and W. Cao, “Relaxor-based ferroelectric single crystals: Growth, domain engineering, characterization and applications,” Progress in Materials Science, vol. 65, pp. 124-210, 2014; S. Zhang, F. Li, X. Jiang, J. Kim and J. Luo, “Advantages and challenges of relaxor-PbTiO₃ ferroelectric crystals for electroacoustic transducers—A review,” Progress in Materials Science, vol. 68, pp. 1-66, 2015). As a result of orientation dependence of elastic constants (sᵢⱼ^{E/D} and cᵢⱼ^{E/D}), a distribution of sound velocity is realized in an active element made of relaxor based single crystal of suitable cuts.

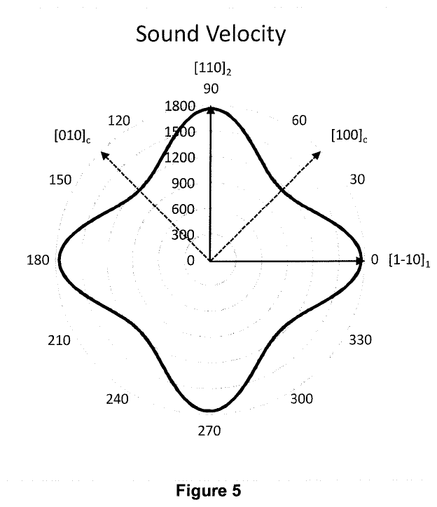

FIG. 5 is a plot of the distribution of sound velocity in the electrode plane of a [001]₃-poled PZN-6% PT thin plate under an electric field as a result of orientation dependence of elastic compliance constant sᵢᵢ^{E}. The sound velocity along each direction is determined using vᵢᵢ^{E}=1̅/̅(̅s̅ᵢ̅ᵢ̅^̅{̅E̅}̅√̅ρ̅)̅, where sᵢᵢ^{E} is the elastic compliance constant in that direction, ρ is the material density. The values of the elastic compliance constants, sᵢᵢ^{E}, are obtained using coordinate transformation from measured properties reported in Shukla et al. (R. Shukla, K. K. Rajan, M. Shanthi, J. Jin and L. C. Lim, “Deduced property matrices of domain-engineered relaxor single crystals of [110]^{L}×[001]^{T} cut: Effects of domain wall contributions and domain-domain interactions,” Journal of Applied Physics, vol. 107, no. 1, p. 014102, 2010). In this figure, the 0° and 90° directions are along the crystallographically equivalent [1-10]₁ and [110]₂ axis, respectively. For a 90° counter-clockwise rotation from 0° (along [1-10]₁ direction), the sound velocity first decreases from its maximum and reaches the minimum at 45° (along [100] crystal direction), and then increases to its maximum again at 90° (along [110]₂ crystal direction).

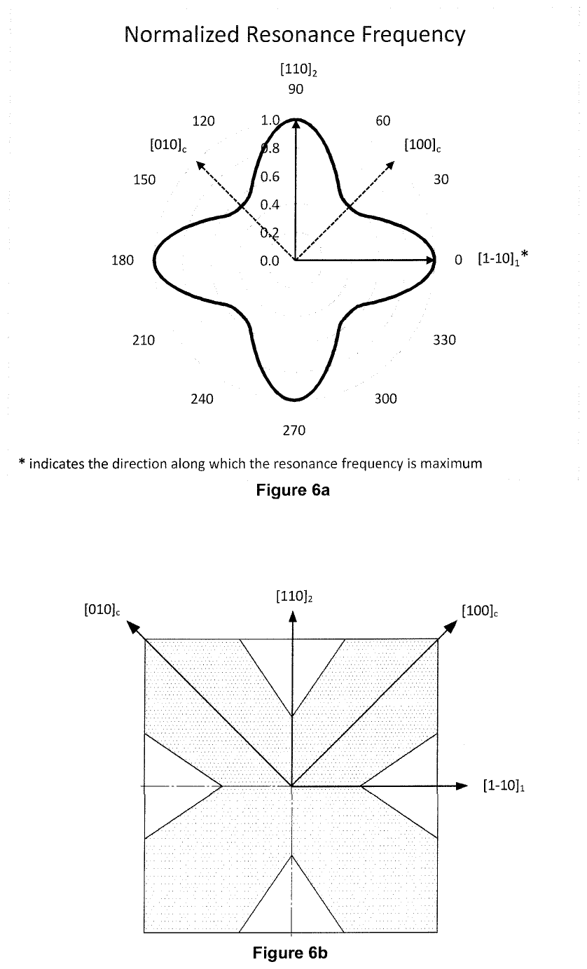

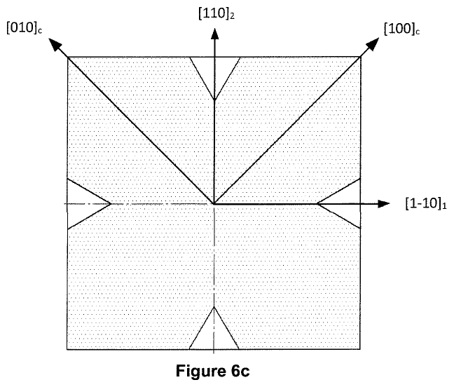

For an active element of known dimensions, the half-wavelength resonance frequency along a particular crystal direction can be estimated based on the sound velocity and the active length in that direction. FIG. 6a is a plot of the half-wavelength resonance frequencies along different directions in the electrode plane of an exemplary 9.6 mm×9.6 mm square-cross-sectioned active element of PZN-6% PT crystal composition and [1-10]₁×[110]₂×[001]₃ cut, where [001]₃ is the poling and LG direction and [1-10]₁ (0° direction) and [110]₂ (90° direction) are the two lateral or transverse directions. The resonance frequencies shown are normalized with respect to the highest values in the electrode plane (i.e., that along the [1-10]₁ and [110]₂ crystal directions).

FIG. 6a shows that for said crystal cut, the minimum resonance frequency is along the [100] and [010] crystal directions, which also happen to be the face diagonal directions on the electrode face of this crystal cut. Along both face diagonal directions, the expected resonance frequency is about 47% of the maximum along both transverse directions of the crystal which, in this case, are the [1-10]₁ and [110]₂ crystal directions. This figure further shows that within the crossed angular slab of material containing both face-diagonals of the electrode face of the active material, the resonance frequency is relatively constant. Said cross-angular slab of active material thus can be activated in resonance when the excitation frequency matches the face-diagonal resonance frequency of said active element, which is expected to be lower than both the LG and the TROB resonances.

FIGS. 6b and 6c depict the (001) electrode face of the exemplary active element in FIG. 6a, wherein the shaded regions give the areas (or volumes) of material displaying comparable diagonal resonance frequencies of 52 kHz (FIGS. 6b) and 56 kHz (FIG. 6c). These figures demonstrate that a substantial portion of material constituting the crossed angular slab containing the crossed-face-diagonals of the electrode face will be set in resonance when the frequency of the alternating input voltage is centered around 52-56 kHz. This unique characteristic leads to the possibility of utilizing the distribution of resonance frequency to excite the DR mode for sound and ultra-sound generation. Meanwhile, such characteristic also points to the possibility of tailoring the resonance frequency and bandwidth of the DR mode by using active material of suitable crystal cut and adjusting the shape of the active element to achieve the required resonance frequency distribution and acoustic characteristics.

For effective activation of the new DR mode of the invention for sound and ultrasound generation, the active material should possess high piezoelectric properties, notably piezoelectric coefficients (dᵢⱼ), electromechanical coupling factors (kᵢⱼ) and relatively high Poisson's ratios (vᵢⱼ).

Active materials exhibiting the desired properties and characteristics include, new-generation relaxor based solid solution piezoelectric single crystals, for example, [001]₃-poled solid solution single crystals of Pb[Zn_{1/3}Nb_{2/3}]O₃—PbTiO₃ (PZN-PT), of Pb[Mg_{1/3}Nb_{2/3}]O₃—PbTiO₃ (PMN-PT), of Pb[Mg_{1/3}Nb_{2/3}]O₃—PbZrO₃—PbTiO₃ (PMN-PZT), of Pb[In_{1/2}Nb_{1/2}]O₃—Pb(Mg_{1/3}Nb_{2/3})O₃—PbTiO₃, (PIN-PMN-PT) and their compositionally modified ternary and quaternary and doped derivatives.

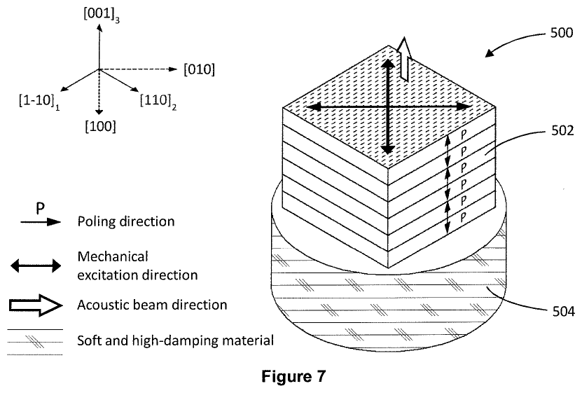

FIG. 7 shows an exemplary multi-crystal transducer 500 designed to operate in the DR mode for generating sound waves of around 55 kHz in water via the half-wavelength resonance mode. Said active element 502 includes six [001]₃-poled PZN-6% PT single crystals of the same crystal cut and dimensions which are connected in parallel electrically. The physical dimensions of both transverse directions of the active element are 9.6 mm, which are the crystallographically equivalent [1-10]₁ and [110]₂ crystal directions. The shaded face shown in the figure indicates electrode on the active element 502. A heavy tail mass 504 is bonded to the bottom face of active element 502 to promote the transmission of the acoustic energy towards the desired top direction. For clarity, the surrounding stress/pressure release materials, lead wires and shims connected to respective electrodes, encapsulation material and housing are not shown in this figure.

Under the DR operating mode described herein, the active element 500 in FIG. 7 will resonate along both face-diagonal directions of the active element as indicated by the double-headed arrows in the figure, which are also the [100] and [010] crystal directions. The strain induced in said resonating face diagonal directions are transferred to the [001]₃ poling direction through the Poisson's ratio effect and generates the intended acoustic beam.

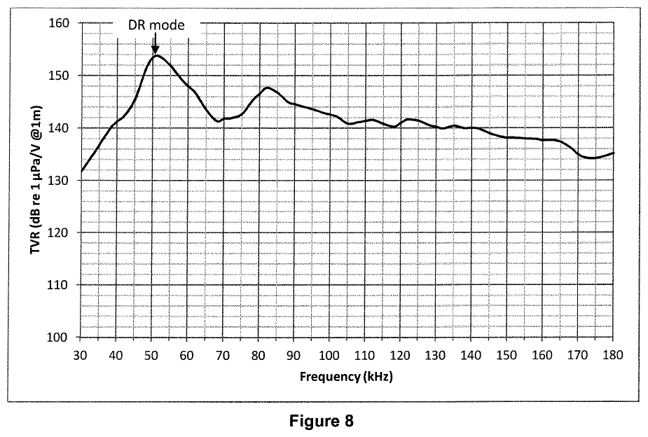

FIG. 8 shows the transmit voltage response (TVR) plot of the exemplary transducer 500 in FIG. 7. The 55 kHz TVR peak is that produced by the design DR mode. It is interesting to note that said DR mode produces a high TVR of 153 dB (re 1 μPa/V at 1 meter) and a high sound pressure level of >191 dB (re 1 μPa at 1 meter) when driven at 80 Vᵣₘₛ without DC bias.

In addition to the TVR peak corresponding to the DR mode of the transducer, FIG. 8 also shows TVR peaks at higher frequencies (>70 kHz), which can be attributed to the TROB mode along both [1-10]₁ and [110]₂ transverse directions, and the LG mode along the [001]₃ poling direction.

As shown in FIG. 8, when appropriately designed, the DR mode can generate significantly high TVR, being at least 8 dB higher than when the same transducer operates in either the TROB or LG mode. The above experimental results confirm that the DR mode is a promising driving mode for sound and ultrasound generation.

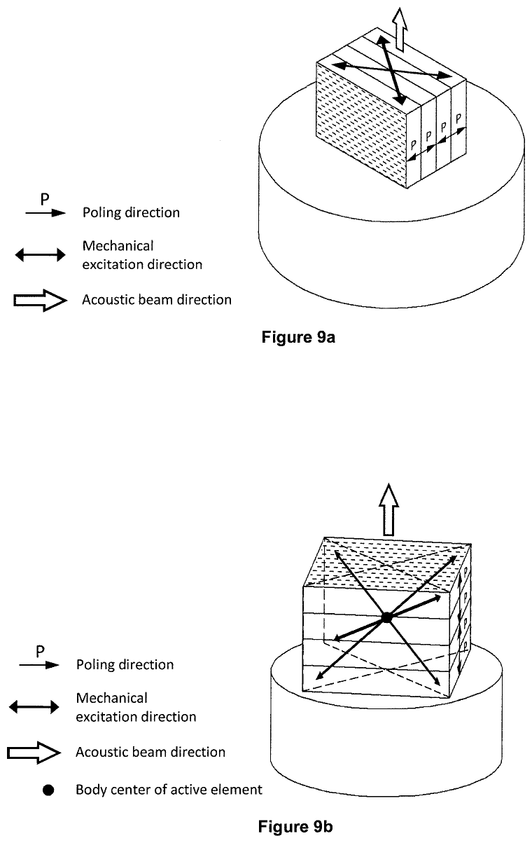

In addition to resonating in the face diagonal directions in the electrode face, the DR mode can also be executed on face diagonal directions on a non-electrode face and along crossed body diagonal directions of an active element, as shown schematically in FIGS. 9a and 9b, respectively. This is possible provided that the said diagonal directions have lower or the lowest sound velocity in the active element.

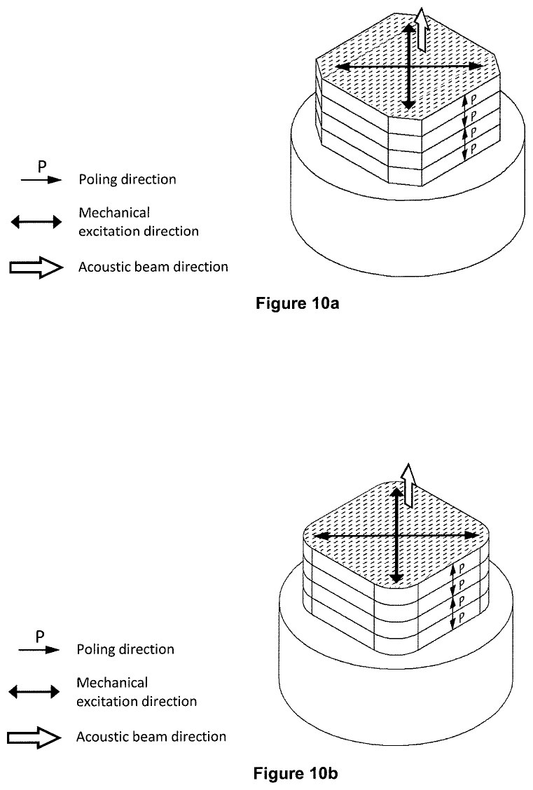

In addition, the shape of the corners of the active element may be modified or adjusted to attain a flatter resonance frequency distribution in the crossed slap of material containing the face or body diagonal of the active material. For example, the corners may be appropriately chamfered, rounded or shaped to any curvatures to promote the DR mode to suit a particular application. Examples of such are provided in FIGS. 10a and 10b.

Further, instead of using active materials of identical dimensions and crystal cuts, the active materials may be of different but comparable dimensions and/or different crystal cuts to suit a particular application, provided that the configuration helps to promote the DR driving mode for sound and ultrasound generation.

The DR mode also applies to transducers with one or more additional masses added to suit a desired application. Such additional mass include a tail mass bonded onto the bottom surface of the active element, an intermediate mass bonded in between the active materials, a head mass of either a rigid or flexural type bonded on the top surface of the active element, a matching layer attached to the acoustic wave emitting face of the active element or a lens layer on top of the matching layer.

The DR mode can be designed to operate under individual mode, in which its resonance frequency is sufficiently far away from other resonance modes.

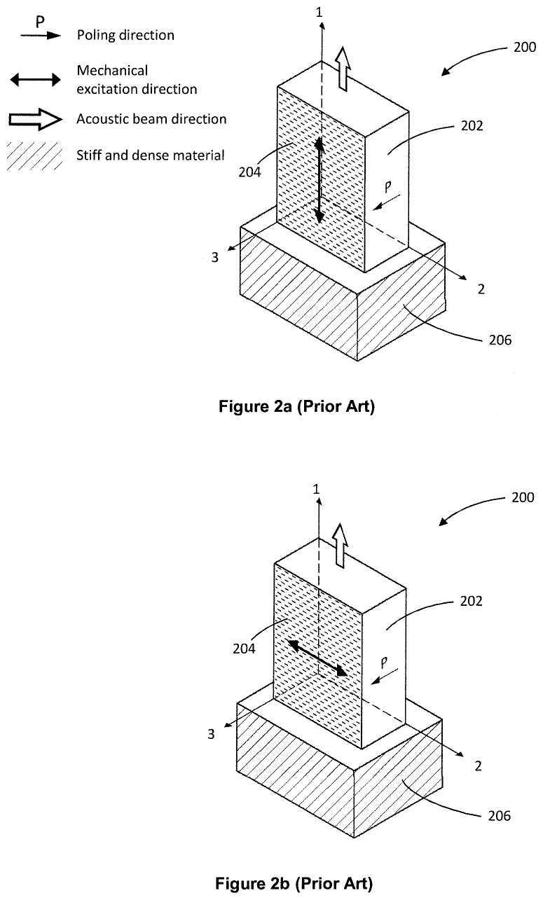

The new DR mode may be used with other resonance modes to form a broadband transducer. In forming a broadband transducer, the resonance frequency of the new DR mode should be sufficiently close to one or more of the driving modes depicted in the prior art (i.e., FIGS. 1 and 2), or to another DR mode. Alternatively, the electrical input to a transducer utilizing the DR mode, under either individual or combined modes operation, can be tuned or adjusted using methods such as external electronics to obtain a desired output to meet the requirements for a particular application.

Furthermore, the invention also applies to sound and ultrasound reception using transducer elements and arrays for sounds of frequencies comparable to the DR mode of the constituting elements in receiving mode. An enhanced receiving sensitivity is achieved in this case compared to when the transducer is working in the off-resonance mode.

The invention described herein further applies to transducers and their arrays for combined sound and ultrasound transmission and reception. Either resonant or off-resonant mode can be used for sound reception in this case.

The transducers and their arrays of the invention described herein find application in a number of fields, including underwater applications such as underwater imaging, ranging and communications with typical operating frequency ranges from low tens of kHz to low tens of MHz; medical applications such as in medical imaging for which typical operating frequencies range from mid hundreds of kHz to high tens of MHz; and industrial applications such as in structural and flaw imaging for which the operating frequencies may vary widely from high tens of kHz to high tens of MHz depending on the material being examined.

It will be obvious to a skilled person that the configurations, dimensions, materials of choice described herein can be adapted, modified, refined or replaced with a different but equivalent method without departing from the principal features of the invention. Further, additional features can be added to enhance the performance and/or reliability of the transducer and array. These substitutes, alternatives, modifications, or refinements are to be considered as falling within the scope and letter of the following claims.

Further, the variations of the above disclosed and other features and functions, or alternatives thereof, can be combined into many other different systems or applications. Also various presently unforeseen or unanticipated alternatives, modifications, variations or improvements can be subsequently made by those skilled in the art which are also intended to be encompassed by the following claims.

1. A transducer comprising an active element of rectangular shape or substantially rectangular shape, electroded on two opposite faces and poled across the electrode faces,
wherein the active element is set either in half-wavelength or quarter-wavelength resonance mode such that the resonating directions are along crossed face-diagonal directions or substantially crossed face-diagonal directions of an external face of the active element, and
wherein an acoustic beam is generated in a direction which is orthogonal or at an acute angle to said resonating direction.

2. A transducer comprising a longitudinal-mode active element of rectangular shape or substantially rectangular shape, electroded on two opposite faces and poled across the electrode faces,
wherein the active element is set in half-wavelength resonance mode such that the resonating directions are along crossed face-diagonal directions or substantially along crossed face-diagonal directions of an electrode face of the active element, and
wherein an acoustic beam is generated along a longitudinal poling direction which is orthogonal to said resonating direction.

3. A transducer comprising an active element of rectangular shape or substantially rectangular shape, electroded on two opposite faces and poled across the electrode faces,
wherein the active element is set either in half-wavelength or quarter-wavelength resonance mode such that the resonating directions are along crossed body-diagonal directions or substantially along crossed body-diagonal directions of the active element, and
wherein an acoustic beam is generated in a direction that is orthogonal or at an acute angle to said resonating direction.

4. A transducer of claim 1, wherein the active element is comprised of a plurality of active materials connected in one of a parallel, series, part-parallel or part-series electrical configuration.

5. A transducer of claim 1, wherein corners of the active element are chamfered, filleted or shaped with curvature to promote a diagonal resonance (DR) mode.

6. A transducer of claim 1, wherein the active element comprises compositions and cuts of piezoelectric single crystals which possess transverse piezoelectric properties of d₃₁ (or d₃₂)≥400 pC/N and k₃₁ (or k₃₂)≥0.60 in at least one of the transverse directions,
wherein d₃₁ and d₃₂ are the associated transverse piezoelectric strain coefficients, and k₃₁ and k₃₂ are the associated electromechanical coupling factors.

7. A transducer of claim 6, wherein the active element is comprised of cuts of relaxor based ferroelectric or piezoelectric single crystals of binary, ternary, and higher-order solid solutions of one or more of Pb(Zn_{1/3}Nb_{2/3})O₃, Pb(Mg_{1/3}Nb_{2/3})O₃, Pb(In_{1/2}Nb_{1/2})O₃, Pb(Sc_{1/2}Nb_{1/2})O₃, Pb(Fe_{1/2}Nb_{1/2})O₃, Pb(Yb_{1/2}Nb_{1/2})O₃, Pb(Lu_{1/2}Nb_{1/2})O₃, Pb(Mn_{1/2}Nb_{1/2})O₃, PbZrO₃ and PbTiO₃, including their modified and/or doped derivatives.

8. A transducer of claim 6, wherein the active element is comprised of a [001]₃-poled single crystal of [1-10]₁×[110]₂×[001]₃ cut, where [001]₃ is the longitudinal direction, and [1-10]₁ and [110]₂ are the two lateral or transverse directions.

9. A transducer of claim 1, wherein the active element is comprised of compositions of textured polycrystalline ceramics which possess transverse piezoelectric properties of d₃₁ (or d₃₂)≥400 pC/N and k₃₁ (or k₃₂)≥0.60 in at least one of the transverse directions,
wherein d₃₁ and d₃₂ are the associated transverse piezoelectric strain coefficients, and k₃₁ and k₃₂ are the associated electromechanical coupling factors.

10. A transducer of claim 1, wherein the active element comprises modified compositions of piezoelectric single crystal or textured polycrystalline piezoelectric ceramics which possess transverse piezoelectric properties of d₃₁ (or d₃₂)≥400 pC/N and k₃₁ (or k₃₂)≥0.60 in at least one of the transverse directions,
wherein d₃₁ and d₃₂ are the associated transverse piezoelectric strain coefficients, and k₃₁ and k₃₂ are the associated electromechanical coupling factors.

11. A transducer of claim 1, further comprising an intermediate mass bonded in between active materials.

12. A transducer of claim 1, further comprising a tail mass bonded onto the face opposite to the acoustic wave emitting face of the active element.

13. A transducer of claim 1, wherein the transducer is a direct-drive, piston-less design.

14. A transducer of claim 1 further comprising a head mass of either a rigid or flexural type.

15. A transducer of claim 1, further comprising at least one matching layer attached to the acoustic wave emitting face of the active element.

16. A transducer of claim 15 further comprising at least one lens layer provided on top of a matching layer to suit a desired application.

17. A transducer of claim 1, that operates in a combined or multi-resonance mode.

18. A transducer of claim 1, that operates in a coupled mode.

19. A transducer of claim 1, used for at least one of sound/ultrasound generation, transmission and reception.
